(19) United States
(12) Patent Application Publication
(10) Pub. No.: US 2025/0392612 A1
(43) Pub. Date: Dec. 25, 2025

(54) SYSTEM AND METHOD FOR DEFENDING AGAINST CYBERSECURITY ATTACKS

(71) Applicant: Miles Higman, Gravette, AR (US)

(72) Inventor: Miles Higman, Gravette, AR (US)

(21) Appl. No.: 19/305,642

(22) Filed: Aug. 20, 2025

Related U.S. Application Data
(60) Provisional application No. 63/662,344, filed on Jun. 20, 2024.

(51) Int. Cl. H04L 9/40

(52) U.S. Cl. CPC H04L 63/1433

(57) ABSTRACT

A computer-implemented method and system for weighing and prioritizing cybersecurity attacks are disclosed. The method includes obtaining data regarding one or more cyber-attacks, generating nodes representing the attacks, calculating edge weights between adjacent nodes using a custom risk function, and outputting a weighted attack graph. Each node is defined by attributes including severity, likelihood, protection level, and layer in a threat model. Edges between nodes are assigned weights that quantify risk based on severity, likelihood of success, and system protection. The resulting weighted attack graph provides an interactive visual representation of potential attack paths, enabling cybersecurity professionals to allocate defensive resources more efficiently and respond to critical threats.

### CROSS REFERENCE TO RELATED APPLICATIONS

This application claims the benefit of U.S. Provisional Application Ser. No. 63/662,344, filed on Jun. 20, 2043, which is hereby incorporated by reference in its entirety.

### BACKGROUND

### Technical Field

The present disclosure generally relates to cybersecurity. More particularly, the present disclosure is directed to weighing and prioritizing cybersecurity attacks.

### Description of the Related Art

Cybersecurity attacks continue to increase in terms of complexity in response to increased efforts to thwart such attacks. Such attacks can be crippling for businesses, and critical infrastructure for essential services and security can be compromised. Identifying and pre-empting such attacks is increasing in difficulty due to the increasing sophistication of hackers, who sometimes work in teams.

Computer networks are susceptible to attack by malicious users (e.g., hackers). Hackers can infiltrate computer networks in an effort to obtain sensitive data such as credit card information and/or to take over control of one or more systems. To defend against such attacks, enterprises use security systems and cyber security professionals to monitor occurrences of potentially adverse events occurring within a network, and alert security personnel to such occurrences.

One challenge of cyber security is the lack of resources against an overwhelming number of attacks or perceived threats. Ideally, security requirements should be prioritized by weighing threats to determine which threats are most imminent or potentially damaging before an event, during an event, and after an event. have to utilize a prioritized decision-making process to determine the order in which security requirements are addressed from a pool of existing and evolving security requirements across all security aspects. By prioritizing security requirements, remediations that need to be performed immediately are given priority, versus remediations that can be deferred. Cybersecurity professionals need to constantly adjust requirements prioritization due to new emerging threats, some of which may be prioritized over known, previously evaluated threats.

### SUMMARY OF THE INVENTION

The present invention disclosure concerns a method and apparatus for weighing and prioritizing cybersecurity attacks by treating each of the attacks as nodes and connecting attack nodes with edges with variable weights. The inventive method allows for system independent prioritization of cybersecurity attacks by obtaining data regarding one or more cyber-attacks; initializing nodes based on the obtained data regarding the one or more cyber-attacks; calculating edge weights for each adjacent node to a first node of the initialized nodes; advancing to additional initialized nodes; reperforming calculating edge weights for each adjacent node in response to determining if each advanced node is connected to other nodes, and outputting a graph in response to determine which of the nodes are not connected to other nodes. Visualizing attack graphs in an interactive 3D environment can provide valuable insights into potential cybersecurity threats and vulnerabilities. Using data visualization software (e.g., Plotly and Dash), cybersecurity professionals can create customized visualizations allowing for deeper analysis and exploration of attack graphs. Customizing the weights of the edges between nodes is essential for prioritizing cybersecurity efforts and mitigating potential risks effectively. The equation presented in this invention disclosure quantitatively measures the risk associated with each attack path, enabling organizations/businesses to allocate resources more efficiently and focus on addressing the most critical security vulnerabilities

In one embodiment, a computer-implemented method and system for code implementation to weigh and prioritize cybersecurity attacks is provided. The visualizing of attack graphs in an interactive environment (including but not limited to 3D) enhances the ability of cybersecurity professional to respond to and remediate cybersecurity threats and vulnerabilities.

In an embodiment, the attacks are treated as attack nodes, and the attack nodes are connected with edges having variable weights, allowing cybersecurity professionals to prioritize attack patterns depending on their system.

In an embodiment, the computer-implemented method includes that the data obtained is from a threat model.

In an embodiment, the computer-implemented method includes that the data obtained is from a threat model that is layered, and the advancing to additional initialized nodes excludes adjacent nodes in the same layer.

### BRIEF DESCRIPTION OF THE DRAWINGS

The drawings presented herein show illustrative embodiments of the disclosure. They do not illustrate all embodiments. Other embodiments may be used in addition to or instead of the illustrative embodiments. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps. The drawings are not intended to depict every feature of every implementation nor relative dimensions of the depicted elements, and are not drawn to scale.

FIG. 1 is a flowchart providing an operational overview of the inventive method of creating a weighted attack graph.

FIG. 2 is a view of the typical hardware associated with a computer-implemented method and a system according to an illustrative embodiment.

FIG. 3 is a table showing an example of an attack scenario.

FIGS. 4 and 5 show graphs generated using the method of the invention.

### DETAILED DESCRIPTION

In the following description, numerous specific details are set forth to clearly describe various specific embodiments disclosed herein. One skilled in the art, however, will understand that the subject matter of the present disclosure may be practiced without all of the specific details discussed below. In other instances, well-known features may not have been described so as not to obscure the invention with unnecessary detail regarding known features.

### Definitions

As used herein, the term “and/or” is to be interpreted broadly is to be understood to refer to all or some of the elements. For example, “at least one of (a) and/or (b) means the teaching pertains only to element (a), or only to element (b), or to both element (a) and element (b). In another example, “at least one of (a), (b), and/or (c), means the teaching pertains to only element (a), or only to element (b), or only element (c), or to elements (a) and (b), elements (a) and (c), elements (b) and (c), or to all of (a), (b) and (c).

A node is a data structure representing a specific attack and the properties of the specific attack. Here is a simple list of the attributes of each:

Name—The name of each node is the name of the general class of attack that node represents. These names can be from any type of threat modeling framework. However, the inventive process and generalized program was made with the MITRE ATT&CK framework in mind.

Layer—The layer of a threat is an optional attribute representing where a certain threat is in a layered threat model and its index relative to the first layer. Giving MITRE ATT&CK as an example, @Reconnaissance@would be layer 0. This attribute constrains what a given node can connect to, as nodes on the same layer shouldn't be connected (after all, they are independent methods of achieving a similar goal).

Likelihood—This attribute is the likelihood this event will occur, assuming the attack reaches a node connecting to this node. There is one precondition to this variable. However, this variable has an extra caveat on a layered model. In general, if two or more independent nodes complete similar tasks, the sum of their likelihoods should be 1.

Protection—This attribute is simply the probability that a network=s protection will stop the attack if a node=s associated attack happens. This variable is always approximated, as certain threats like 0-day vulnerabilities can=t be known to measure protection accurately. Also, many attacks may not get to certain nodes, making the value of this variable more uncertain. However, it is important to give some estimates via defense evaluations. This attribute is simply the probability that a network's protection will stop the attack if a node's associated attack happens. This variable is always approximated, as certain threats like 0-day vulnerabilities can't be known to measure protection accurately. Also, many attacks may not get to certain nodes, making the value of this variable more uncertain. However, it is important to give some estimates via defense evaluations.

Severity—This attribute is a quantity bounded between 0 and 1 that quantitatively measures the repercussions where the attack each node describes were to occur. This data can be collected from statistical modeling or an Meta Language (ML) program that measures some sort of @impact coefficient@ that can be bounded.

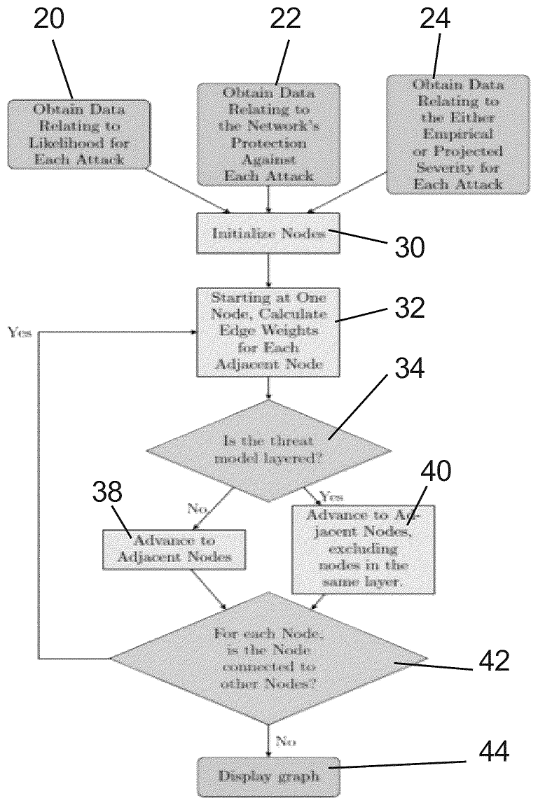

FIG. 1 is a flowchart illustrating a method consistent with an illustrative embodiment. The flowchart represents a sequence of operations, the order of which is variable. In each process, the order in which the operations are described is not intended to be construed as a limitation, and any number of the operations can be combined in any order and/or performed in parallel to implement the process.

The process is initiated by obtaining data to initialize the attack nodes as shown in blocks 20, 22, and 24. Specifically, data regarding likelihood of each attack, data regarding the network's protection against each attack, and data regarding either the empirical or projected severity of the attack are obtained. This information is used to initialize the nodes as shown in block 30, the initialization being done to assess and categorize the threat posed by the node. Starting at a first node, the edge weights for each adjacent node are calculated in accordance with the inventive formula as discussed below as shown in block 32. In decision block 34, an assessment of whether the threat is layered (as defined above) is made. If the threat is layered, the process advances to block 38 where it advances to adjacent nodes, excluding nodes in the current layer. If the threat is not layered, the process advances to block 40 to advance to adjacent nodes. A determination of whether each node is connected to another node is performed in block 42. For each node not connected to another node a graph is output in block 44, and the process is terminated for that node. For each node connected to another node, the inventive process loops back to block 32 to calculate edge weights for all of the connected nodes.

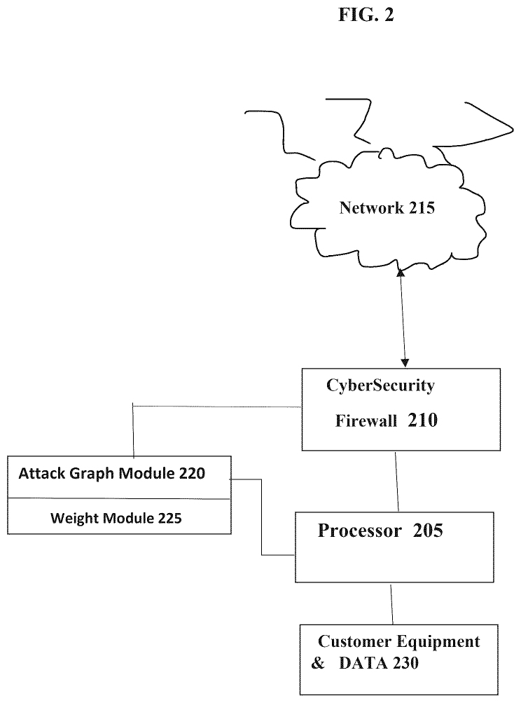

FIG. 2 shows a non-limiting example of hardware that may be used with a system and a computer-implemented method of the present disclosure. FIG. 2 depicts an example architecture in accordance with implementations of the present disclosure. In the depicted example, the architecture includes client devices 230, and a network firewall 210, the client devices 230 sending and receiving data from network 210. Between the network firewall 215 and the client devices 230 the inventive cybersecurity system, formed of an attack graph module 220 and weight module 225 are positioned, the output of which is sent to processor 205 which generates graphs illustrating potential attacks using the method of the invention. The graphs generated by this arrangement allow for visualizing attacks in 3D, this allowing cybersecurity professionals to more accurately assess threats as will be described in more detail later.

### Defining an Edge

An edge is a data structure connecting two nodes that has three attributes:
$ Start—The starting node of the edge.
$ End—The ending node of the edge.
$ Weight—The @importance@ of an edge. This value is calculated by using the properties of both the start and end nodes.

### Customizing Edge Weights

In addition to visualizing attack graphs, the attack graph can be rendered to customize the visualization to highlight important features of the graph. One way to do this is by customizing the weights of the edges between nodes. The weight of an edge can represent the severity of the attack path it represents, the likelihood of the attack being successful, or a combination of both.

### Significance of Edge Weights

Customizing edge weights is a basis for prioritizing cybersecurity efforts and mitigating potential risks effectively. By assigning weights to the connections between nodes in the attack graph, cybersecurity professionals can identify critical attack paths that pose the highest risk to the system. By assigning weights to the connections between nodes in the attack graph, cybersecurity professionals can identify critical attack paths that pose the highest risk to the system. This allows organizations to allocate resources more efficiently and focus on addressing the most pressing security vulnerabilities. This implementation of a weight function can be thought of as almost a “z-score” for cybersecurity threats. In addition to visualizing attack graphs, there can be customization to highlight essential features of the graph. One way to do this is by customizing the weights of the edges between attack nodes. The weight of an edge can represent the severity of the attack path it represents, the likelihood of the attack being successful, or a combination of both

### Equation for Calculating Edge Weights

The weight of an edge between two nodes can be calculated using a custom equation that considers various factors such as severity, likelihood, and protection level. The equation provides a quantitative measure of the risk associated with each attack path, allowing cybersecurity professionals to prioritize their response accordingly.

The equation is as follows:

$$w = f ( s , l , ρ ) = {p}_{part} ( 1 − σ ( \frac{\partial p}{\partial t} ) ) [ l \text{?} {s}_{part} ( 1 − σ ( \frac{\partial s}{\partial t} ) ) ( 1 − σ ( \frac{\partial l}{\partial t} ) + {l}_{part} ( 1 − σ ( \frac{\partial l}{\partial t} ) ) σ ( \frac{\partial s}{\partial t} ) + {s}_{part} ( 1 − σ ( \frac{\partial s}{\partial t} ) ) σ ( \frac{\partial l}{\partial t} ) + σ ( \frac{\partial s}{\partial \text{?}} ) σ ( \frac{\partial l}{\partial t} ) ]$$

$${s}_{p a r t} = \{ \begin{matrix}s + ( 1 - s ) μ \text{?} & 0 < s < 1 \\ 0 & s = 0\end{matrix}$$

$${l}_{p a r t} = \{ \begin{matrix}\text{?} + ( 1 − l ) μ \text{?} & 0 < \text{?} \leq 1 \\ 0 & l = 0\end{matrix}$$

$${p}_{p a r t} = ( 1 − p )$$

$$\text{?} \text{indicates text missing or illegible when filed}$$

Where:
w is the weight of the edge.
s is the severity of the attack.
l is the likelihood of the next attack occurring, given that the first attack occurred.
p is the protection level of the destination node.
f is a custom function that calculates the weight based on the given parameters.

### Not Considering Derivatives

This equation can easily be modified to work with single data points (which don't have a derivative), like so:
wconst=ppartlpartspart.

### Breakdown of Graph Generation Code

### Overview

The provided code uses Dash and Plotly to generate a 3D scatter plot representing different stages of an attack with connections (edges) between them. The points on the graph represent different attack stages with attributes such as severity, likelihood, and protection.

### Edge Weights

Edge weights are calculated using a custom function to calculate weight at a constant rate. The weight function considers the severity, likelihood, and protection values of connected points. The formula used is:

$$w = 5 \times ( 1 - p ) \times ( 1 + ( 1 - 1 ) \times tolerance of likelihood ) \times ( s + ( 1 - s ) \times tolerance of severity )$$

where:
s is the severity of the destination point.
la and lb are the likelihoods of the source and destination points.
p is the protection value of the destination point.
tolerance of severity=0.5
tolerance of likelihood=0.5

### Algorithmic Process of Generating the Graph

1. Initialization: Import necessary libraries and define the number of data points per x-coordinate and custom labels for the x-axis.
2. Coordinate Generation:
   Reverse the list num points per x list.
   Generate x-coordinates based on the number of data points per x-coordinate.
   Generate corresponding labels for each stage.
3. Data Point Generation:
   Generate random y-values (severity) and z-values (likelihood) for each point.
   Normalize the z-values to ensure they sum up to 1.
   Generate random sizes for the spheres representing data points.
4. Connection Generation: Create a list of connections between points where the x-coordinate of one point is one less than the other.
5. Scatter Plot Creation: Create a 3D scatter plot of the data points with hover text displaying detailed information.
6. Edge Plot Creation: For each connection, calculate the weight and create a line (edge) with a width proportional to the weight.
7. Layout Configuration: Define the layout of the 3D plot, including axis titles and aspect ratio.
8. Dash Application Setup: Initialize the Dash application, define the layout, and implement a callback function to handle click events and draw lines between clicked points.

### Features of the Graph

3D Scatter Plot: The graph displays data points in a 3D space with x-axis representing stages, y-axis representing severity, and z-axis representing likelihood.
Hover Text: Each data point has hover text showing its name, stage, severity, likelihood, and protection.
Connections (Edges): The graph shows connections between points with widths based on calculated weights.
Interactive Click Events: Users can click on points to draw connections manually, with edges being dynamically added to the graph.

### Analysis of Graph Generated Using the Method of the Invention.

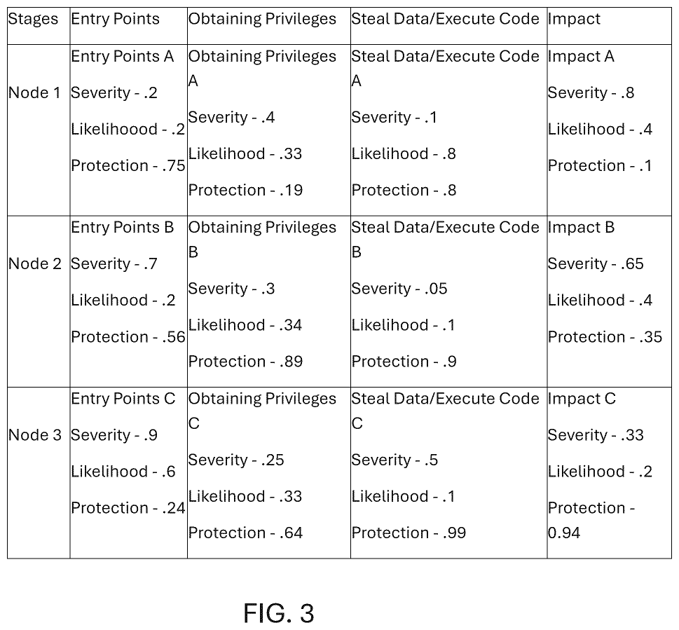

Referring now to FIG. 3, a table of possible attacks by 3 nodes, numbered 1-3, is shown. The table is organized by showing the numbered/named nodes in the left hand column. The stages (layers) of the hypothetical attack are listed on the top row. It should be noted that the numbers for severity, likelihood, and protection are between 0 and 1 as discussed above. To a cybersecurity professional, there are some obvious conclusions that can be drawn based on the numbers in the table. First of all, though other entry points are also formidable, for any attacker, Entry Point C is an obvious choice as indicated by the severity, likelihood, and protection numbers. In fact, the analysis will conclude that the organization's first priority should be locking down entry points B and C. Also, we can note that Obtaining Privileges A seems to be significantly less protected and more severe than the other attacks on its layer. Also, though most of the attacks on the Steal Data/Execute Code layer are well protected, Steal Data/Execute Code A is significantly more likely. Finally, Impact A and Impact B are both very severe, with only a small amount of protection. Thus, an attacker would most likely attack like so: Entry Point C→Obtain Privileges A→Steal Data/Execute Code A→Impact A and Impact B.

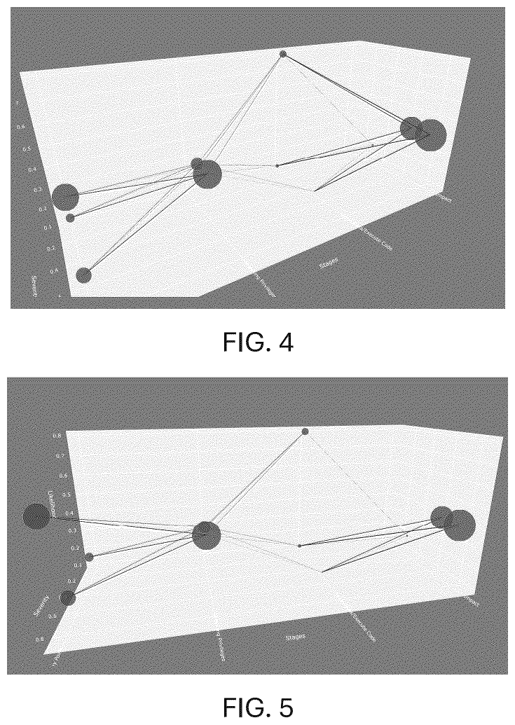

The graph of this network is shown in FIG. 4. Looking at the graph, it is easy to see the big circles with bold lines connecting them, which clearly illuminates the path made previously within seconds. Not only can this way of viewing data be faster, but it can also reveal hidden issues in certain pipelines more easily.

As an example, assume Steal Data/Execute Code A CANNOT result in Impact A or Impact B. Then, the graph would look like FIG. 5. First, note that the potential pipeline for the first two layers will not change. Also, note that even though Steal Data/Execute Code A is still significantly more severe and likely than the other two attacks on its layer, it should NOT be prioritized for bugfixes, as it only leads to a somewhat mild impact. From the weight of the lines, it is clear to see that Steal Data/Execute Code B is more dangerous, even if it is the least severe threat in the graph. This is because Impacts A and B, which are very dangerous, are most likely to result from that attack due to its slightly lower protection statistic as opposed to Steal Data/Execute Code C. Note that with this graph, it is easy to impose restrictions and see threats that could indirectly be a problem later down the line.

Code Listing

import dash
from dash import dcc, html
from dash.dependencies import Input, Output
import plotly.graph_objs as go
import numpy as np
# Define the number of data points per x-coordinate
num_points_per_x_list = [3, 5, 4, 6, 7, 3, 3, 4, 5, 4, 2, 2, 1, 2]
# Sample list of data points per x-coordinate
num_points_per_x_list.reverse( )
# Define custom labels for x-axis
custom_labels = [‘Reconnaissance’,
‘Resource Development’,
‘Inital Access’,
‘Execution’,
‘Persistance’,
‘Privilege Escalation’,
‘Defense Evaluation’,
‘Credential Access’,
‘Discovery’,
‘Laterial Movement’,
‘Collection’,
‘Command and Control’,
‘Exfiltration’,
‘Impact’]
letters = ‘abcdefghijklmnopqrstuvwxyz’
names = [ ]
label_for_stages = [ ]
# Generate x-coordinates based on the number of data points per x-coordinate
x_coordinates = [ ]
for i, num_points in enumerate(num_points_per_x_list):
x_coordinates.extend([len(num_points_per_x_list)−1−i] * num_points_per_x_list[−(i+1)])
label_for_stages.extend([custom_labels[i] * num_points_per_x_list[−(i+1)])
for j in range(num_points_per_x_list[−(i+1)]):
names.append(custom_labels[i] +f“ ({letters[j]})”)
print(label_for_stages)
# Generate random spherical data points on the x-coordinates
x = x_coordinates
num_layers = len(num_points_per_x_list)
print(x)
custom_labels.reverse( )
# Initialize y-values list
z = [ ]
# Generate random y-values for each layer
for i in range(num_layers):
# Generate random probabilities for each data point in the layer
probabilities = np.random.rand(num_points_per_x_list[−(i+1)])
print(f“Stage {i}”)
print(sum(probabilities))
# Normalize probabilities to ensure they sum up to 1
probabilities /= np.sum(probabilities)
print(probabilities)
print(sum(probabilities))
z.extend(probabilities)
print(z)
y = np.random.uniform(0, 1, len(x))
# Generate random sizes for spheres
sizes = np.random.uniform(0, 100, len(x))
print(x)
connections = [ ]
for i in range(len(x)−1):
for j in range(1, len(x)):
if x[i]−1 == x[j]:
connections.append((i,j))
attack_hover_text = [
f“Name = {names[i]}\
<br>Stage = {label_for_stages[i]}\
<br>Severity = {y[i]}\
<br>Likelihood = {z[i]}\
<br>Protection = {1− sizes[i]/100}”
for i in range(len(x))]
# Define scatter plot for data points
scatter = go.Scatter3d(
name=“Attacks”,
x=x,
y=y,
z=z,
mode=‘markers’,
marker=dict(size=sizes, color=‘red’),
hoverinfo=‘text’, # Show hover text
text=attack_hover_text
)
def calculate_weight_at_const_rate(s, l_a, l_b, p):
#TODO: Weight function doesn't seem to be getting the right values
tolerance_of_severity = 0.5
tolerance_of_likelihood = 0.5
if l_a == 0 or l_b == 0:
return 0
1 = (l_a * l_b) / l_a
if s == 0:
return 0
w = (1−p)*(1 + (1−1)*tolerance_of_likelihood)*(s + (1−s)*tolerance_of_severity)
return w*5
# Define scatter plot for connections with different widths
lines = [ ]
for connection in connections:
i, j = connection
w = calculate_weight_at_const_rate(y[j], z[i], z[j], 1−(sizes[j]/100))
hover = f‘Weight = {w/5}\
<br>Change in Severity = {y[j]−y[i]}\
<br>Change in Likelihood = {z[j]−z[i]}’
line = go.Scatter3d(
name=f“ {names[i]}−{names[j]}”,
x=[x[i], x[j]],
y=[y[i], y[j]],
z=[z[i], z[j]],
mode=‘lines’,
line=dict(color=‘blue’, width=w), # Random width for each line
hoverinfo=‘text’, # Disable hover for connections
hovertext=hover,
meta=w/5 # Store weight as metadata
),
lines.append(line)
# Sort connections based on weight (descending order)
lines.sort(key=lambda line: line.meta, reverse=True)
# Define layout with gridlines and adjusted x-axis range
layout = go.Layout(
scene=dict(
xaxis=dict(title=‘Stages’,\
gridcolor=‘white’,\
zeroline=False,\
titlefont=dict(color=‘white’),\
tickfont=dict(color=‘white’),\
ticktext=custom_labels,\
tickvals=list(range(len(custom_labels)))),
yaxis=dict(title=‘Severity’,\
gridcolor=‘white’,\
zeroline=False,\
aspectmode=‘manual’, # Manual control of aspect ratio
aspectratio=dict(x=2.5, y=1, z=1) # Increase the relative length of the x-axis
),
paper_bgcolor=‘grey’ # Set background color to black
)
# Create plotly figure
fig = go.Figure(data=[scatter, *lines], layout=layout)
fig.update_xaxes(
gridcolor=“black”
)
fig.update_yaxes(
gridcolor=“black”
)
# Initialize global variable to store clicked points
clicked_points = [ ]
# Create Dash app
app = dash.Dash(_{——}name_{——})
# Define app layout
app.layout = html.Div([
dcc.Graph(
id=‘graph’,
figure=fig,
style={‘width’: ‘100vw’, ‘height’: ‘100vh’}
# Set width and height to viewport width and height
),
])
# Define callback function for click event
@app.callback(Output(‘graph’, ‘figure’), [Input(‘graph’, ‘clickData’)])
def draw_line(clickData):
global clicked_points
if clickData:
if ‘points’ in clickData:
points = clickData[‘points’]
if len(points) == 1:
p = points[0][‘pointNumber’]
clicked_points.append(p)
print(clicked_points)
if len(clicked_points) == 2:
p1, p2 = clicked_points
if(p1==p2):
clicked_points = [ ]
return
if(p1>p2):
p2, p1 = p1, p2
x1, y1, z1 = fig[‘data’][0][‘x’][p1],\
fig[‘data’][0][‘y’][p1],\
fig[‘data’][0][‘z’][p1]
x2, y2, z2 = fig[‘data’][0][‘x’][p2],\
fig[‘data’][0][‘y’][p2],\
fig[‘data’][0][‘z’][p2]
w = calculate_weight_at_const_rate(y2, z1, z2, 1−(sizes[p2]/100))
line_trace_name1 = f“{names[p1]}−{names[p2]}”
line_trace_name2 = f“{names[p2]}−{names[p1]}”
line_index = None
for i, trace in enumerate(fig[‘data’]):
if trace[‘name’] == line_trace_name1 or\
trace[‘name’] == line_trace_name2:
line_index = i
if line_index is None:
print(“add”)
fig.add_scatter3d(
name=line_trace_name1,
x=[x1, x2],
y=[y1, y2],
z=[z1, z2],
mode=‘lines’,
line=dict(color=‘blue’, width=w),
hoverinfo=‘text’, # Enable hover for the line
hovertext=f‘Weight = {w/5}\
<br>Change in Severity = {y2−y1}\
<br>Change in Likelihood = {z2−z1}’,
meta=w/5 # Store weight as metadata
)
clicked_points = [ ] # Reset clicked points
return fig
if _{——}name_{——} == ‘_{——}main_{——}’:
app.run_server(debug=True)

While several illustrative embodiments of the present disclosure have been shown and described, numerous variations and alternative embodiments will occur to those skilled in the art. Such variations and alternative embodiments are contemplated, and can be made without departing from the scope of the disclosure as defined in the appended claims.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one”: unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, paragraph (f), unless the element is expressly recited using the phrase “means for. and no method or process step herein is to be construed under those provisions unless the step, or steps, are expressly recited using the phrase “step(s) for . . . .”

What is claimed is:

1. A computer-implemented method of weighing and prioritizing cybersecurity attacks comprising the steps of:
obtaining data regarding one or more cyber-attacks, and generating a node for each of said one or more cyber-attacks;
initializing a first one of said nodes based on the obtained data regarding the one or more cyber-attacks;
calculating edge weights for each adjacent node to said first node of the initialized nodes;
advancing to additional initialized nodes;
reperforming calculating edge weights to produce a set of edge weights, one for each of said adjacent nodes to determine if each advanced node is connected to other nodes,
outputting a graph based on said set of edge weights, the graph providing a visual representation of said one or more cyber-attacks.

2. The computer-implemented method according to claim 1, wherein the obtaining of data regarding one or more cyber-attacks is obtained is from a layered threat model.

3. The computer-implemented method according to claim 2, wherein the data obtained is from a layer of said threat model, wherein the advancing to additional initialized nodes excludes adjacent nodes in the said layer.

4. The computer-implemented method according to claim 1, wherein the edge weights are calculated according to:
$$w = f ( s , l , p ) = p\_p ⋆ ( 1 - o ( \partial p / \partial t ) ) ⋆ [ l\_p ⋆ s\_p ⋆ ( 1 - σ ( \partial s / \partial t ) ) ⋆ ( 1 \_σ ( \partial l / \partial t ) ) + l\_p ⋆ ( 1 - σ ) ⋆ σ ( \partial s / \partial t ) + s\_p ⋆ ( 1 - σ ( \partial s / \partial t ) ) ⋆ σ ( \partial l / \partial t ) + σ ( \partial s / \partial t ) ⋆ σ ( \partial l / \partial t ) ] ;$$
$$Where : \_p = \{ s + ( 1 - s ) μ\_s if 0 < s \leq 1 ; 0 if s = 0 \} l\_p = \{ 1 + ( 1 - l ) μ\_l if 0 < l \leq 1 ; 0 if l = 0 \} p\_p = ( 1 - p ) and :$$
w is the weight of the edge, s is the severity of the attack, l is the likelihood of another attack occurring, given that a first attack occurred, p is the protection level of the destination node, and f is a custom function that calculates the weight based on the given parameters.

5. A system for weighing and prioritizing cybersecurity attacks, comprising:
a processor configured to execute instructions stored in memory;
an attack graph module configured to generate nodes corresponding to attacks;
a weight module configured to calculate edge weights between said nodes; and
an output interface configured to generate an interactive visual representation of weighted attack graphs.
